(19) United States
(12) Patent Application Publication
(10) Pub. No.: US 2011/0005851 A1
(43) Pub. Date: Jan. 13, 2011

(54) Vehicle grille including adjustable louvers, and/or method of making the same

(76) Inventors: William J. Doroghazi, Livonia, MI (US); Curtis B. Reid, Shelby Township, MI (US)

Correspondence Address: NIXON & VANDERHYE, PC, 901 NORTH GLEBE ROAD, 11TH FLOOR, ARLINGTON, VA, 22203, US

(21) Appl. No.: 12/801,403

(22) Filed: Jun. 7, 2010

Related U.S. Application Data
(60) Provisional application No. 61/213,767, filed on Jul. 13, 2009.

(51) Int. Cl. B60K 11/04; B60R 19/52; B23P 15/12

(52) U.S. Cl. 180/68.1; 180/68.6; 29/897.15

(57) ABSTRACT

In certain example embodiments of this invention, there is provided a grille for a vehicle (e.g., a car, truck, SUV, or the like). In certain example embodiments, the vehicle grille includes adjustable louvers. In certain example embodiments, the louvers are configured to change position relative to the grille (e.g., to rotate, slide, or otherwise move) when a predetermined condition is met (e.g., vehicle speed above/below a predefined threshold, wind speed above/below a predefined threshold, etc.). This configuration advantageously may result in better vehicle performance (such as, for example, better fuel efficiency), e.g., related to less drag and/or improved aerodynamics.

### CROSS-REFERENCE TO RELATED APPLICATION

This application claims the benefit of U.S. Application Ser. No. 61/213,767, filed Jul. 13, 2009, the entire content of which is hereby incorporated herein by reference.

### FIELD OF THE INVENTION

Certain example embodiments of this invention relate to a grille for a vehicle (e.g., car, truck, SUV, or the like) and, more particularly, to a vehicle grille including adjustable louvers. In certain example embodiments, the louvers are configured to change position relative to the grille (e.g., to rotate, slide, or otherwise move) when a predetermined condition is met (e.g., vehicle speed above/below a predefined threshold, wind speed above/below a predefined threshold, etc.). This configuration advantageously may result in better vehicle performance, e.g., related to less drag.

### BACKGROUND AND SUMMARY OF EXAMPLE EMBODIMENTS OF THE INVENTION

Vehicle front grilles are known in the art. Indeed, there are many variations of decorative grille assemblies in the automotive marketplace. Many decorative grille assemblies include cosmetic designs around typically centrally located grille badges. These cosmetic designs sometimes include holes or other openings, bars, beams, mesh-like patterns, and/or the like. A great deal of work often is involved in designing the cosmetic features of grilles, e.g., to make sure that the overall grille “matches” the vehicle, the manufacturer's trade dress, or any intended deviations therefrom (e.g., in the case of the desire to create a new or distinctive line, product, etc.).

Unfortunately, such conventional techniques suffer from several drawbacks and further improvements could still be made. For example, few (if any) grilles that currently are commercially available are perfectly flat and contoured so as to optimize the aerodynamics of the vehicle, e.g., by causing the air to flow around the vehicle at high speeds. Oftentimes, there is a tradeoff between the cosmetic appearance of a grille and its ability to provide engineering benefits to the vehicle such as, for example, accomplishing the somewhat related and/or other tasks of improving aerodynamics, reducing drag, increasing fuel efficiency, and/or the like.

Thus, it will be appreciated that there is a need in the art for improved vehicle grilles and/or methods of making the same.

One aspect of certain example embodiments of this invention relates to vehicle grilles that include movable louvers that are selectively movable.

Another aspect of certain example embodiments of this invention relates to causing one or more louver(s) to change position relative to a vehicle grille (e.g., to rotate, slide, or otherwise move), when a predetermined condition is met.

Still another aspect of certain example embodiments of this invention relates to causing louvers at least partially concealed within and/or behind a grille to close to reduce drag and/or otherwise improve the aerodynamics of the vehicle.

In certain example embodiments of this invention, a grille for a vehicle is provided. The grille includes at least one decorative opening. At least one adjustable louver is integrated into the grille on an interior side thereof, with the at least one adjustable louver being configured to rotate and/or slide between at least first and second positions when a predetermined condition is met or not met. The first position is an open position, and the second position is a closed position that at least partially closes the at least one decorative opening. According to certain example embodiments, the at least one louver is further configured to rotate and/or slide between a third position between the first and second positions when a second predetermined condition is met or not met.

In certain example embodiments of this invention, a vehicle including a grille is provided. The grille comprises at least one decorative opening. At least one adjustable louver is integrated into the grille on an interior side thereof, with the at least one adjustable louver being configured to rotate and/or slide between a plurality of discrete positions when predetermined conditions are met or not met. A first position in the plurality of discrete positions is an open position, and a second position in the plurality of discrete positions is a closed position that at least partially closes the at least one decorative opening.

Methods of making the same also are provided in certain example embodiments of this invention.

The features, aspects, and advantages of the example embodiments described herein may be combined in any combination or sub-combination to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a front partial perspective view of a vehicle grille in accordance with an example embodiment;

FIG. 2 is a front view of the vehicle grille of FIG. 1 in accordance with an example embodiment;

FIG. 3 is a cross-sectional view of the vehicle grille of FIG. 1 taken through the approximate center line C/L in accordance with an example embodiment;

FIG. 4 is a cross-sectional view of the vehicle grille of FIG. 1 taken through section A-A in accordance with an example embodiment;

FIG. 5 is a cross-sectional view of a conventional vehicle grille similar to that shown in FIG. 1 taken through section B-B;

FIG. 6 is a cross-sectional view of the vehicle grille of FIG. 1 taken through section B-B in accordance with an example embodiment;

FIG. 7 is a cross-sectional view of the vehicle grille of FIG. 1 taken through section B-B in accordance with another example embodiment;

FIG. 8 is a cross-sectional view of the vehicle grille of FIG. 1 taken through section B-B in accordance with still another example embodiment;

FIG. 9 is a front schematic view of an example grille and components thereof, in accordance with an example embodiment; and

FIG. 10 is an example louver in accordance with an example embodiment.

### DETAILED DESCRIPTION OF EXAMPLE EMBODIMENTS OF THE INVENTION

Certain example embodiments of this invention relate to a vehicle grille including adjustable louvers (e.g., a grille for a vehicle such as a car, truck, SUV, or the like). In certain example embodiments, the louvers are configured to change position relative to the grille (e.g., to rotate, slide, or otherwise move) when a predetermined condition is met (e.g., vehicle speed above/below a predefined threshold, wind speed above/below a predefined threshold, etc.). This configuration advantageously may result in better vehicle performance (such as, for example, better fuel efficiency), e.g., related to less drag and/or improved aerodynamics.

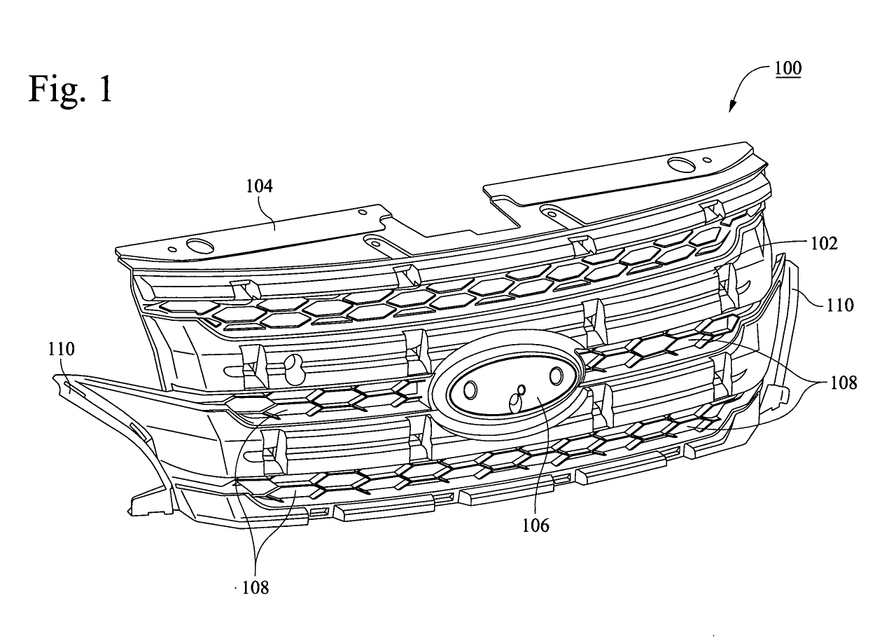

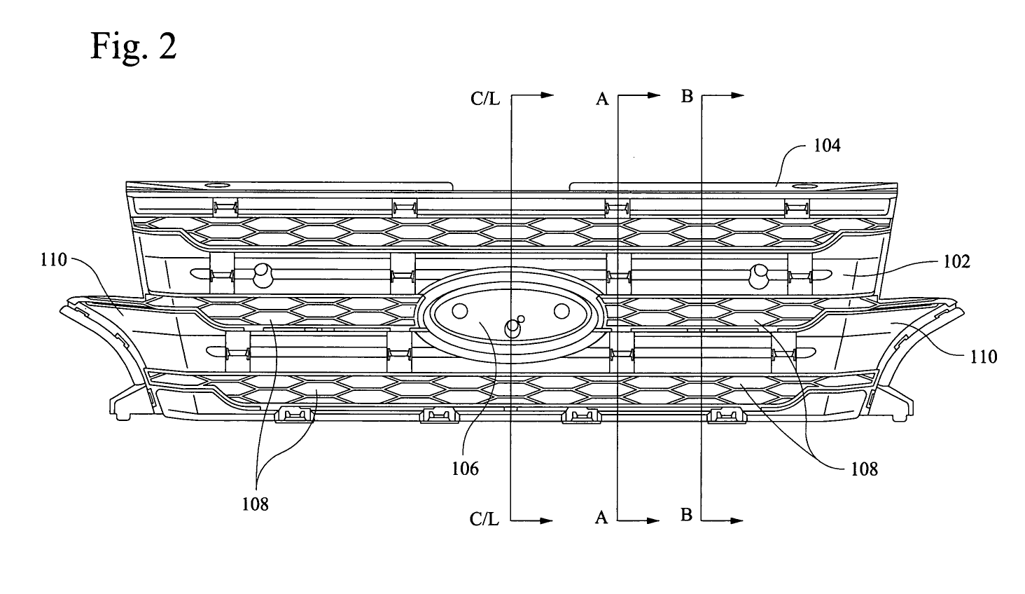

Referring now more particularly to the drawings in which like reference numerals indicate like parts throughout the several views, FIG. 1 is front partial perspective view of a vehicle grille 100 in accordance with an example embodiment, and FIG. 2 is a front view of the vehicle grille of FIG. 1 in accordance with an example embodiment. As shown in FIGS. 1 and 2, the grille 100 includes a main body portion 102. A “beauty cover” 104 is integral with (connected to or formed as a one-piece structure with as by, for example, molding into) the main body portion 102. Beauty cover 104 may extend over some or all of the width of the grille. This arrangement may conceal the radiator, headlamp assemblies, etc. In certain example embodiments, the beauty cover 104 may fulfill robust structural support requirements, for example, to hold a significant load when a mechanic leans on it to reach the interior portions of the vehicle. The beauty cover and/or the main body portion 102 of the grille may be connected to the vehicle by any suitable fastening means. For example, a plurality of screws, fasteners, snap features, and/or the like may be provided in certain example embodiments. See, for example, commonly assigned application Ser. No. 11/896,939, the entire contents of which are hereby incorporated herein by reference, which also describes a structural inner grille component and a decorative outer grille component, which may be adapted for use in connection with certain example embodiments of this invention.

A grilled badge attachment area 106 may be provided, for example, in the approximate width-wise and/or height-wise center of the grille 100. The grille badge may be connected to the main body portion 102 of the grille 100 using any suitable techniques. See, for example, commonly assigned U.S. Publication No. 2009/0140549, the entire contents of which are hereby incorporated herein by reference. Decorative features 108 may be provided in the main body portion 102 of the grille 100. As shown in FIGS. 1 and 2, for example, the decorative features 108 include honeycomb-like webbing. Of course, other features such as, for example, bar, holes, openings, mesh areas, and/or the like may be provided in connection with different embodiments of this invention. In any event, the grille 100 includes optional side portions 110, which at least partially wrap around the front of the vehicle, potentially at least partially surrounding the vehicle's headlights, fog lights, or other features.

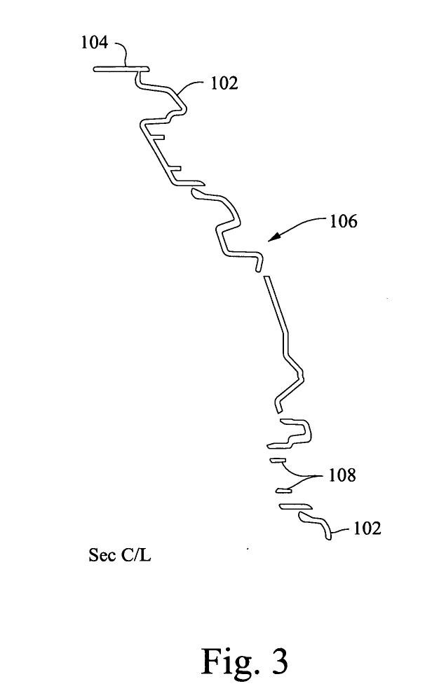

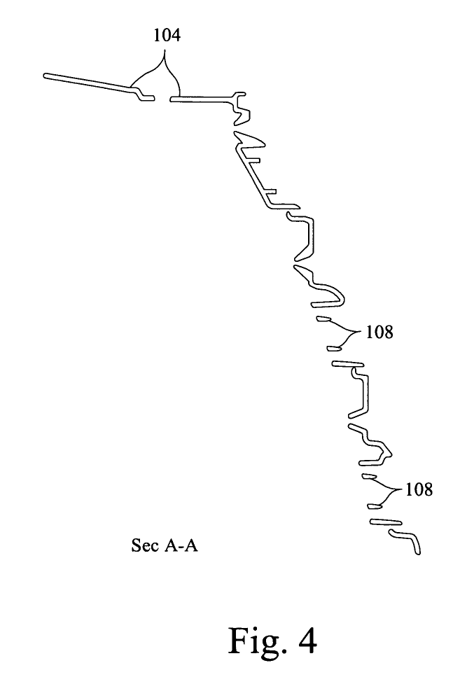

FIG. 3 is a cross-sectional view of the vehicle grille of FIG. 1 taken through the approximate center line C/L in accordance with an example embodiment, and FIG. 4 is a cross-sectional view of the vehicle grille of FIG. 1 taken through section A-A in accordance with an example embodiment.

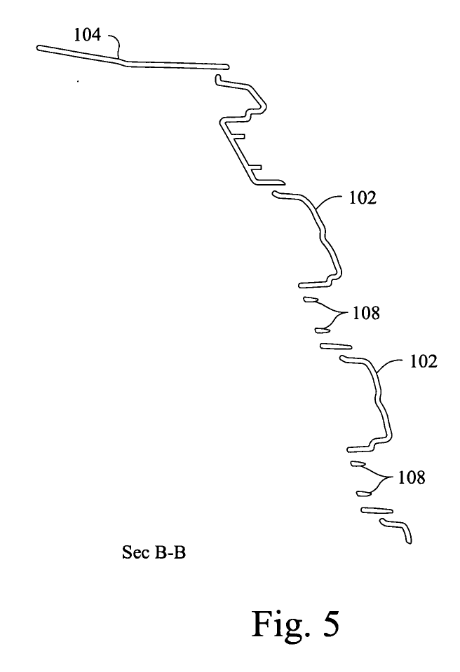

FIG. 5 is a cross-sectional view of a conventional vehicle grille similar to that shown in FIG. 1 taken through section B-B. As can be seen perhaps best in FIG. 5, air will flow into and around the circled areas around the decorative features 108 as the vehicle moves. As the vehicle moves more and more quickly, this airflow will at least partially enter the vehicle as opposed to be aerodynamically forced around it, thereby increasing drag and potentially reducing fuel efficiency as vehicle works harder to compensate for the increase in drag.

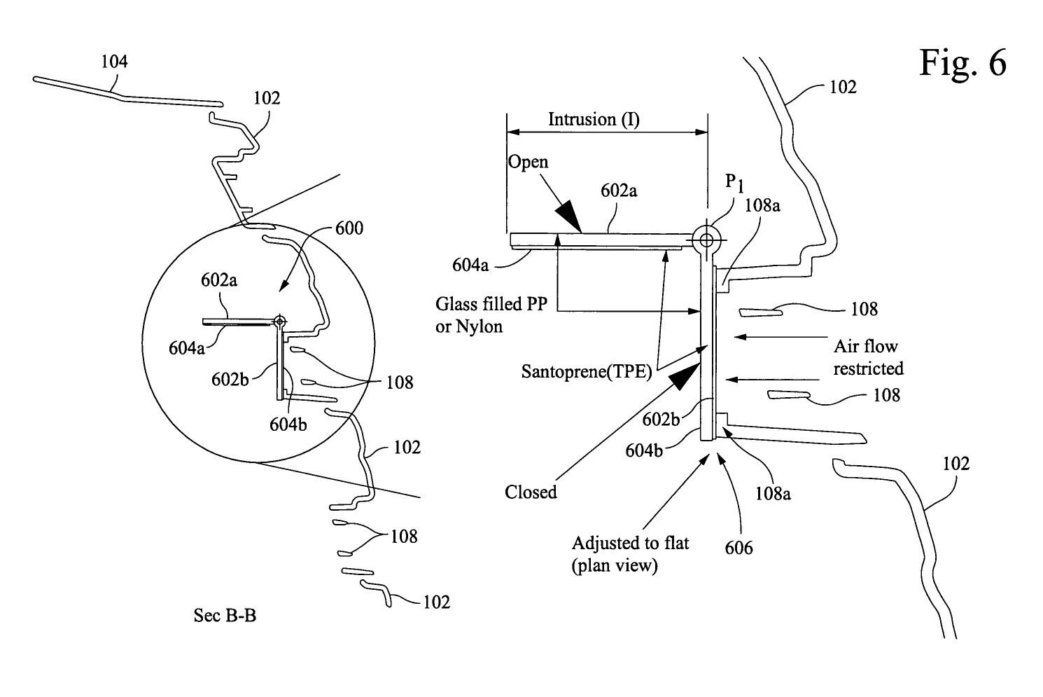

As alluded to above, certain example embodiments incorporate features that help improve the aerodynamics of the vehicle and/or reduce drag. In particular, certain example embodiments include louvers that are configured to change position relative to the grille (e.g., to rotate, slide, or otherwise move) when a predetermined condition is met (e.g., vehicle speed above/below a predefined threshold, wind speed above/below a predefined threshold, etc.). These louvers may help “seal off” the openings provided by the decorative features 108, thereby helping to force the airflow around the vehicle and, in turn, improving aerodynamics by reducing drag. In this regard, FIGS. 6-8 provide several example views of how the louvers may operate.

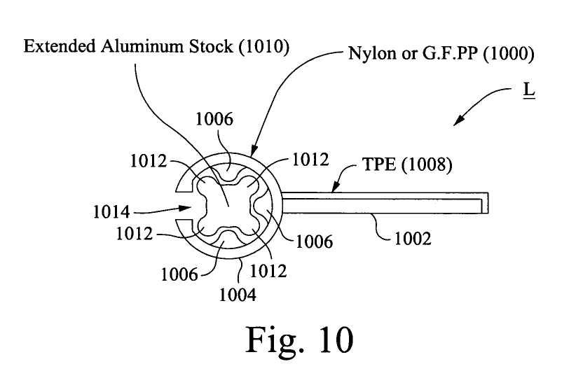

The louver may be made of, for example, a glass-filled polypropylene, nylon, or other material in certain example embodiments. A sealant coating or strip of sealing material may be applied to a surface of the louver, e.g., so as to help form a better seal between the features of the grille and the louver. For example, a thermoplastic elastomer such as, for example, Santoprene, may be used in certain example embodiments. Further example louver design details are provided below, e.g., in connection with FIG. 10.

FIG. 6 shows a rotating louver design 600 in accordance with an example embodiment. The louver rotates about a pivot point P1. The pivot point P1 is located “behind” the grille 100 and “in front” of the frame of the vehicle. In its “open” position, the louver is substantially parallel to the ground, e.g., so that it is difficult or impossible to see from the outside of the vehicle. Thus, for example, when the vehicle is parked and/or travelling at low speeds, one observing the vehicle grille 100 may not be able to determine that any louvers are present through the decorative features 108. The louver also may be at different angles relative to the ground in its open position. Regardless of the angle, the louver may intrude a predetermined distance I at maximum.

When the louver is in its open position (602a) in the FIG. 6 example embodiment, the sealing strip (604a) faces downward and, when the louver is its closed position (602b) in the FIG. 6 example embodiment, the strip (604b) may contact the inner edges 108a of the grille 100. In so doing, the airflow as the vehicle travels forward may be restricted and may not enter into the interior of the vehicle to the extent that it otherwise would. Unlike the FIG. 5 example, the inner edges 108a of the grille 100 may be adjusted “to flat” so as to provide an increased amount of area to help form the seal. For example, as shown at area 606, the bottom surface may be “L-shaped” so that the sealing strip 604b may form a better seal by virtue of the increased contact area.

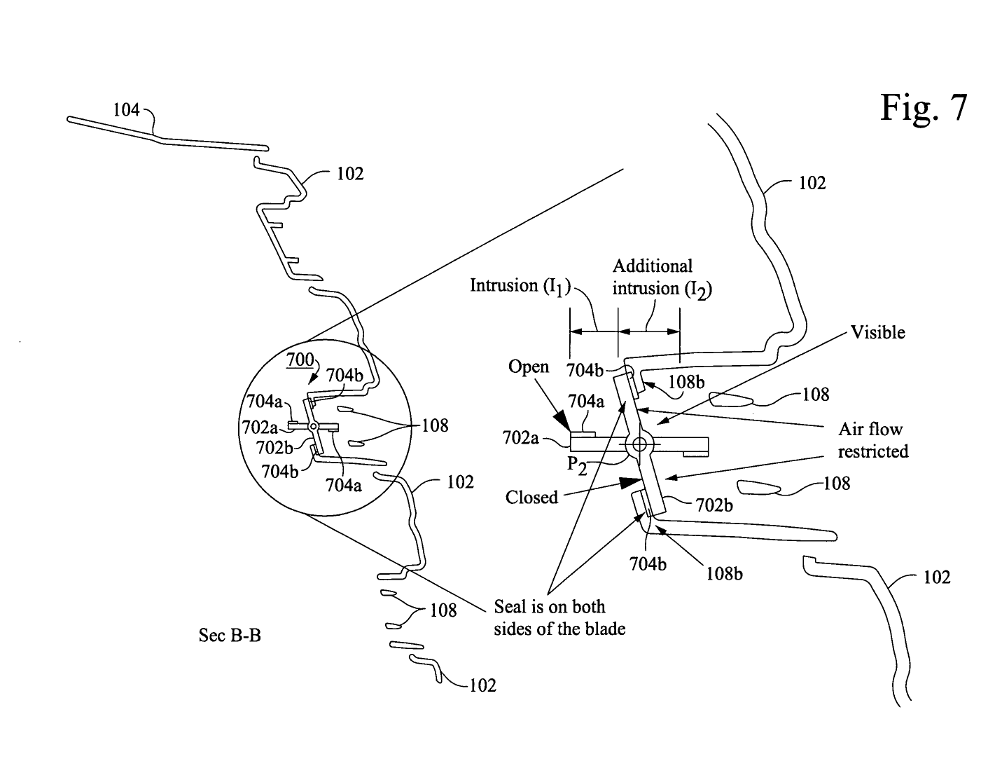

FIG. 7 shows another rotating louver design 700 in accordance with an example embodiment. Similar to the FIG. 6 example embodiment, the louver in the FIG. 7 example embodiment rotates about a pivot point P2. However, this pivot point P2 is located in the approximate center of the decorative area. As above, in its “open” position, the louver is substantially parallel to the ground, e.g., so that it is difficult or impossible to see from the outside of the vehicle because it is fairly thin and/or largely concealed by the decorative features 108 themselves and may appear to be, if anything, a part of the vehicle frame. Although the louver also may be at different angles relative to the ground in its open position, parallel or substantially parallel is generally advantageous in that it reduces the overall view of the louver mechanism. Regardless of the angle, the louver may intrude a predetermined distance I1 into the “interior” of the grille 100 and will intrude a second predetermined distance 12 outwardly from the pivot point P2.

Sealing material may be provided on opposing surfaces of the louver in the FIG. 7 example embodiment. Furthermore, the sealing material may be provided at only the peripheral edge portions thereof in certain example embodiments (although other design implementations are possible, e.g., where the sealing material is provided along the entire or substantially the entire half portion of the louver). The FIG. 7 example embodiment involves a clockwise rotating louver. Thus, in its open position (702a), the sealing material (704a) is provided on the upper surface on the interior side and on the lower surface on the exterior side. Thus, when the blade rotates, the sealing material contacts the angled inner edges 108b of the grill 100. Of course, it will be appreciate that the blades may be made to rotate counterclockwise, and the location of sealing material may be switched in such example embodiments.

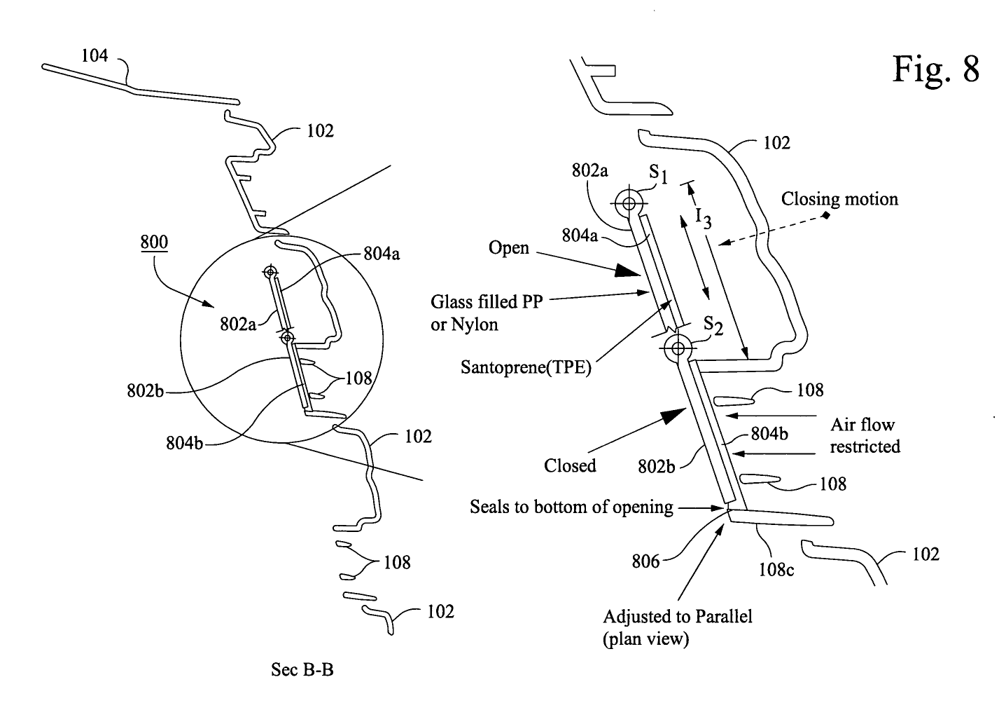

Unlike the FIGS. 6 and 7 example embodiments, FIG. 8 involves a sliding louver design. The FIG. 8 sliding louver slides from position S1 (open) to S2 (closed) and intrudes a predetermined distance 13 into the grille. As above, the louver includes sealing material, which is located on the surface of the louver that faces the exterior of the vehicle. Thus, in its closed position (802b), the sealing material (804b) faces towards the exterior of the vehicle. Additionally, the sealing material 806 may be provided at an angle and/or at least partially around the louver, e.g., so that it forms a seal with the top surface of the portion 108c of the vehicle grille 100. The sliding louver of FIG. 8 may move substantially vertically (up and down) with respect to the grille. The louver in the FIG. 8 example embodiment, however, is angled so as to match the inner contours of the grille 100, thereby reducing the overall profile needed for the louver in the open position while also providing for a perhaps better seal once in the closed position.

Although not illustrated, a sliding louver also may be provided, e.g., such that it moves substantially horizontally along the face of the grille between open and closed positions.

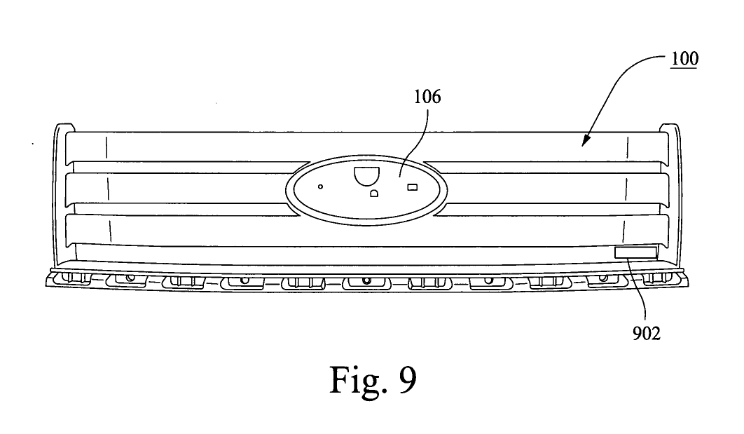

FIG. 9 is a front schematic view of an example grille and components thereof, in accordance with an example embodiment. As shown in FIG. 9, a sensor 902 is provided proximate to the grille. This sensor may measure, for example, wind noise (e.g., using an audio sensor), which may be mounted no the grille and wired back through the vehicle electronics to send a signal to an actuator to cause the vents to open or close, as appropriate. When wind noise is above a certain threshold volume, the louvers may be caused to close. Subsequently, when wind noise drops below a certain threshold volume, the louvers may be caused to open. In certain example embodiments, excessive wind noise above a certain threshold may cause the louvers to open so that the added airflow pressure does not cause them to break. In certain example embodiments, rather than using an audio sensor, the actuator system may be tied into the vehicle's speedometer, a GPS unit, etc. In certain example embodiments, a heat sensor may be provided, e.g., such that the louvers are opened in the event that the engine becomes too hot. Of course, it will be appreciated that other sensors may be used in connection with different example embodiments.

FIG. 10 is an example louver L in accordance with an example embodiment. The size and the shape of the louver L may depend on, for example, the particular grille into which the louver L is to be located. For instance, the sizes and/or shapes of the areas to be selectively blocked may have an impact on the corresponding size and shape of the louver L. The louver L shown in FIG. 10 includes a main body 1000, which may be formed from, for example, nylon, glass filled polypropylene, etc. The louver L includes a protrusion 1002 that serves as the main structure for the air-blocking features of certain example embodiments. The seal 1008 is provided on at least one major surface thereof. In the FIG. 10 example, the seal 1008 extends at least partially around the protrusion 1002.

An end portion 1004 of the main body 1000 of the louver L may be substantially circular, e.g., so as to facilitate rotation thereof. The end portion 1004 may have teeth 1006 formed therein so as to engage with corresponding teeth 1012 of an inner member 1010. In certain example embodiments, the inner member 1010 may be aluminum. An opening area 1014 in the end portion 1004 of the main body 1000 of the louver L that corresponds with the space between the teeth 1012 of the inner member 1010 may be configured to receive an actuator arm from a motor controlling the opening and closing of the louver L. That is, in certain example embodiments, the louver L may be keyed into the linkage (active side) and then assembled to a flange on the grille (passive side), e.g., so as to cause the selective rotation and/or translation of the louver.

In certain example embodiments, the louver may be extruded (e.g., from nylon or glass filled polypropylene). In such example embodiments, the louver may be co-extruded with the inner member (e.g., which may be extruded from aluminum stock). Of course, in certain other example embodiments, the louver may be injection-molded.

Although certain example embodiments have been described as relating to either rotating or translating louvers, certain example embodiments may combine rotational and translational movements in the selective opening/closing of the louvers. Furthermore, although certain example embodiments have been describes as being formed from certain materials, it will be appreciated that other materials and/or other techniques for processing those materials may be used.

As will be appreciated from the above, certain example embodiments of this invention may involve the rotational and/or translational movement of at least one adjustable louver between at least first and second positions when predetermined conditions are met or not met. These conditions may, in certain example instances, correspond to wind noise, speed, and/or other thresholds being met or exceeded and, in certain example instances, the first and second positions may correspond to “fully opened” and “fully closed” positions. However, different example embodiments may involve a plurality of “partially opened” or “partially closed” positions that are matched with corresponding discrete or continuous thresholds. In other words, in certain example embodiments, the louvers may be partially opened and/or partially closed as the vehicle moves down the road between a maximum and minimum percentages (e.g., 10-90%) to allow for predetermined portions of air to pass through the grille. Thus, in certain example instances, a grille may be opened to a maximum extent and closed to discrete positions as successive thresholds are met, and vice versa. As a more concrete example, a louver may be fully open when the vehicle is traveling at or less than 10 mph, and the louver may close by 10% increments at every 5 mph increase such that it is fully closed when the vehicle reaches a speed of at least 60 mph. In this example, the louvers may open or re-open as the vehicle slows at the same or similar thresholds. In still other example embodiments, the louvers may fully close once a threshold is met and “open up” predetermined amounts as successive thresholds are passed (e.g., as the vehicle is slowed, as wind speed drops, etc.). In still other example embodiments, the louvers may fully open once a threshold is met and close predetermined amounts as successive thresholds are passed (e.g., as the vehicle speeds up, as wind speed increases, etc.).

Although certain example embodiments have referred to the movable members as “louvers,” it will be appreciated that the term “louvers” may be used to refer to, for example, shutters, vanes, rods, vents, and/or the like.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A grille for a vehicle, comprising:
at least one decorative opening; and
at least one adjustable louver integrated into the grille on an interior side thereof, the at least one adjustable louver being configured to rotate and/or slide between at least first and second positions when a predetermined condition is met or not met,
wherein the first position is an open position, and
wherein the second position is a closed position that at least partially closes the at least one decorative opening.

2. The grille of claim 1, wherein the at least one louver is made of a glass-filled polypropylene or nylon.

3. The grille of claim 1, wherein the at least one louver is co-extruded with an inner member of the grille.

4. The grille of claim 1, further comprising sealant material provided to the at least one louver that helps for a seal between features of the grille and the at least one louver when the at least one louver is in the closed position.

5. The grille of claim 4, wherein the sealant material is a thermoplastic elastomer.

6. The grille of claim 1, wherein the at least one louver is arranged so as to rotate about a pivot location located on an interior side of the grille in moving between the at least first and second positions.

7. The grille of claim 6, wherein the at least one louver is substantially parallel to the ground in the first position and substantially perpendicular to the ground in the second position.

8. The grille of claim 8, wherein the pivot location is located in the approximate center of the height of the at least one decorative opening.

9. The grille of claim 1, wherein the predetermined condition corresponds to a wind noise threshold.

10. The grille of claim 1, wherein the predetermined condition corresponds to a speed threshold.

11. The grille of claim 1, wherein the at least one louver is configured to rotate and/or slide between a third position between the first and second positions when a second predetermined condition is met or not met.

12. A vehicle including a grille, the grille comprising:
at least one decorative opening; and
at least one adjustable louver integrated into the grille on an interior side thereof, the at least one adjustable louver being configured to rotate and/or slide between a plurality of discrete positions when predetermined conditions are met or not met,
wherein a first position in the plurality of discrete positions is an open position, and
wherein a second position in the plurality of discrete positions is a closed position that at least partially closes the at least one decorative opening.

13. The vehicle of claim 12, further comprising a sensor configured to gather data associated with the predetermined conditions.

14. The vehicle of claim 13, wherein the sensor is configured to gather data pertaining to wind noise.

15. The vehicle of claim 13, wherein the sensor is configured to gather data pertaining to vehicle speed.

16. The vehicle of claim 13, further comprising a mechanical actuator configured to cause the at least one louver to change positions based on data gathered by the sensor.

17. The vehicle of claim 12, further comprising sealant material provided to the at least one louver that helps for a seal between features of the grille and the at least one louver when the at least one louver is in the closed position.

18. The vehicle of claim 12, wherein the at least one louver is arranged so as to rotate about a pivot location located on an interior side of the grille in moving between the at least first and second positions.

19. A method of making a grille for a vehicle, the method comprising:
providing the grille; and
integrating at least one adjustable louver into the grille on an interior side thereof, the at least one adjustable louver being configured to rotate and/or slide between at least first and second positions when a predetermined condition is met or not met,
wherein the first position is an open position, and
wherein the second position is a closed position that at least partially closes the at least one decorative opening.

20. The method of claim 19, wherein the grille comprises an inner member and an outer member, and further comprising co-extruding the at least one louver with the inner member of the grille.
